(19) United States
(12) Patent Application Publication
(10) Pub. No.: US 2026/0170598 A1
(43) Pub. Date: Jun. 18, 2026

(54) Image Processing System, Method, Device and Computer Readable Storage Medium

(71) Applicants: Beijing BOE Optoelectronics Technology Co., Ltd., Beijing (CN); BOE Technology Group Co., Ltd., Beijing (CN); Beijing BOE Technology Development Co., Ltd., Beijing (CN)

(72) Inventors: Xiantao LIU, Beijing (CN); Yonghui WANG, Beijing (CN); Chen MENG, Beijing (CN); Bo FU, Beijing (CN); Wenjie ZHONG, Beijing (CN); Guo LIU, Beijing (CN); Haibo YU, Beijing (CN)

(21) Appl. No.: 18/712,264

(22) PCT Filed: Aug. 8, 2023
(86) PCT No.: PCT/CN2023/111622

§ 371 Date: May 22, 2024

(51) Int. Cl. G06T 1/60

(52) U.S. Cl. CPC G06T 1/60

(57) ABSTRACT

An image processing system, which includes a main control chip, a memory, a cache and a clock generator respectively connected with the main control chip, and the memory and the cache are connected with each other. The memory is configured to store a predetermined plurality of image correction parameters; the cache is configured to acquire a plurality of image data to be processed; the clock generator is configured to provide a clock signal for controlling writing or reading of the image correction parameters in the memory, the clock signal includes at least a first clock signal; the main control chip is configured to generate a first read instruction under the control of the first clock signal and send it to the memory to control the memory to read out the plurality of image correction parameters to the cache.

### CROSS-REFERENCE TO RELATED APPLICATION

The present application is a U.S. National Phase Entry of International Application No. PCT/CN2023/111622 having an international filing date of Aug. 8, 2023. The above-identified application is hereby incorporated by reference.

### TECHNICAL FIELD

The present disclosure relates to, the field of detector technology, in particular to an image processing system, method, device and computer readable storage medium.

### BACKGROUND

A flat X-ray panel detector (FPXD) is a device which converts the energy of X-ray into digital image. FPXD is an important component in digital image technology. Due to its advantages such as fast imaging speed, good spatial and density resolution, high signal-to-noise ratio and direct digital output, it is widely used in the fields of medical imaging (such as X-ray chest radiography), industrial inspection (such as metal detection), security inspection, air transportation.

The production and preparation process for the FPXD is complex, with high requirements for the process and production accuracy, and any minor fluctuations generated during the preparation process may have an impact on the output image. However, in the actual implementation scenario, process fluctuations inevitably exist in the production and preparation process of the FPXD, which in turn leads to the deviations in the pixel parameters of the image. Therefore, the correction of the images captured by the FPXD has become an urgent problem to be solved.

In related technologies, the FPXD-based image correction algorithm is processed by a host computer software. For example, after image data is captured on the computer side, a corresponding algorithmic processing is performed to achieve image correction, and the image is finally displayed on a screen. At present, most of image correction algorithms are static image acquisition, while FPXD image acquisition has the characteristics of a larger dynamic range, high acquisition speed and frame rate, and the dynamic acquisition with high frame rate puts higher requirements on the processing capability of the host computer software. In this case, the processing capacity of the algorithm is limited, and it cannot carry such a high amount of data. In view of this, part of the content that is originally processed by the algorithm can be transferred to the board hardware for processing.

### SUMMARY

Embodiments of the present disclosure provide an image processing system, method, device, and computer readable storage medium.

In a first aspect, embodiments of the present disclosure provide an image processing system, comprising a main control chip, a memory, a cache, and a clock generator respectively connected to the main control chip, the memory is configured to store a predetermined plurality of image correction parameters;
the cache is configured to acquire a plurality of image data to be processed; the clock generator is configured to provide a clock signal for controlling writing or reading of the image correction parameters in the memory, the clock signal includes at least a first clock signal;
the main control chip is configured to generate a first read instruction under the control of the first clock signal and send it to the memory to control the memory to read out the plurality of image correction parameters to the cache; and receive the image correction parameters and the image data to be processed sent by the cache, and perform correction processing to obtain the corrected image data.

In some embodiments, the clock signal further comprises a second clock signal; the image processing system also comprises a processor connected with the main control chip,
the processor is configured to determine the image correction parameters; and generate a parameter issuing instruction and send it to the main control chip;
the main control chip is further configured to: send the image correction parameters to the cache at a first communication rate in response to the parameter issuing instruction; at the same time, under the control of the second clock signal, generate a data writing instruction and send it to the cache;
the cache is configured to receive the plurality of image correction parameters, and in response to the data writing instruction, write the plurality of image correction parameters to the memory at a second communication rate;
wherein the first communication rate is greater than the second communication rate.

In some embodiments, the plurality of image correction parameters include a plurality of first parameter groups, each of the first parameter groups includes a sub-parameter corresponding to each pixel point in a frame image, and image correction types corresponding to the sub-parameters in different first parameter groups are different;
the cache is specifically configured to sequentially write the plurality of the first parameter groups into the memory in a preset order at the second communication rate in response to the data writing instruction.

In some embodiments, the main control chip is further configured to:
after the plurality of the first parameter groups are all stored in the memory, generate a first feedback instruction and send it to the processor, wherein the first feedback instruction is used to indicate the completion of the issue of the plurality of the first parameter groups.

In some embodiments, the image processing system further comprises a processor connected to the main control chip,
the processor is configured to generate a parameter postback instruction and send it to the main control chip;
the main control chip is further configured to generate a second read instruction under the control of the first clock signal in response to the parameter postback instruction and send the second read instruction to the memory;
the memory is configured to read out the plurality of image correction parameters to the cache at a second communication rate in response to the second read instruction;
the cache is configured to upload the plurality of image correction parameters to the processor via the main control chip at a first communication rate;
wherein the first communication rate is greater than the second communication rate.

In some embodiments, a plurality of image correction parameters include a plurality of second parameter groups, each of the second parameter groups includes a plurality of sub-parameters corresponding to one of pixel points in a frame image, pixel points corresponding to the sub-parameters in different second parameter groups are different;
the cache is specifically configured to sequentially receive a plurality of second parameter groups in the memory according to a preset order at the second communication rate.

In some embodiments, the cache is specifically configured to:
sequentially receive a plurality of second parameter groups in the memory in a preset order at the second communication rate;
post back the plurality of second parameter groups to the processor via the main control chip at a first communication rate after all second parameter groups have been received.

In some embodiments, the frame image includes n pixel points, and the plurality of image correction parameters includes a first sub-parameter, a second sub-parameter, and a third sub-parameter corresponding to each pixel point;
the cache is specifically configured to write n first sub-parameters, n second sub-parameters and n third sub-parameters to the memory sequentially at the second communication rate in response to the data writing instruction;
the memory is specifically configured to read out three sub-parameters corresponding to pixel point 1 to pixel point n to the cache sequentially at the second communication rate in response to the second read instruction.

In some embodiments, the clock signal further comprises a second clock signal;
the image processing system further comprises a processor connected with the main control chip, wherein the processor is configured to generate an image correction instruction and send it to the main control chip;
the main control chip is further configured to generate a first read instruction under the control of the second clock signal in response to the image correction instruction and send the first read instruction to the memory;
the memory is further configured to read out a plurality of image correction parameters to the cache at a second communication rate in response to the first read instruction.

In some embodiments, the plurality of image correction parameters include a plurality of second parameter groups, each of the second parameter groups includes a plurality of sub-parameters corresponding to one of pixel points in a frame image, pixel points corresponding to the sub-parameters in different second parameter groups are different;
the memory is specifically configured to sequentially read the plurality of second parameter groups in a preset order at a second communication rate in response to the first read instruction, so as to cache them in the cache.

In some embodiments, the cache is further configured to perform data consolidation on the plurality of image data to be processed and the plurality of second parameter groups to determine the image data to be processed and the second parameter group corresponding to each pixel point, and send them to the main control chip;
the main control chip is specifically configured to, according to the image data to be processed and the second parameter group corresponding to each pixel point, perform image correction processing on each pixel point in a plurality of pixel points in the frame image to obtain corrected image data corresponding to each pixel point.

In some embodiments, the frame image includes n pixel points, and the plurality of image correction parameters includes a first sub-parameter, a second sub-parameter, and a third sub-parameter corresponding to each pixel point;
the cache is specifically configured to write n first sub-parameters, n second sub-parameters and n third sub-parameters to the memory sequentially at the second communication rate in response to the data writing instruction;
the memory is specifically configured to read out three sub-parameters corresponding to pixel point 1 to pixel point n to the cache sequentially at the second communication rate in response to the first read instruction;
the cache is further configured to perform following acts in a preset order for pixel point 1 to pixel point n:
receive three sub-parameters corresponding to pixel point i, at the same time, configuring image data to be processed corresponding to the pixel point i, and sending the image data to be processed corresponding to the pixel point i and the three sub-parameters to the main control chip, wherein, 1≤i≤n.

In some embodiments, the processor is further configured to:
receive a plurality of corrected image data at a first communication rate;
form a corrected frame image based on the plurality of corrected image data;
wherein the first communication rate is greater than the second communication rate.

In some embodiments, the first communication rate is 0.7 Gbit/s to 10 Gbit/s and the second communication rate is 40 Mbit/s to 60 Mbit/s.

In some embodiments, the image processing system further comprises a processor and an image acquisition module respectively connected with the main control chip,
the processor is configured to generate an image acquisition instruction and send it to the main control chip;
the main control chip is configured to control the image acquisition module to perform data acquisition in response to the image acquisition instruction;
the image acquisition module is configured to acquire the plurality of image data to be processed according to a frame image and send them to the cache.

In a second aspect, embodiments of the present invention provide an image processing method, which includes:
acquiring a plurality of image data to be processed and a predetermined plurality of image correction parameters;
acquiring a clock signal for controlling writing or reading of the image correction parameters in the memory, the clock signal comprises at least a first clock signal;
under the control of the first clock signal, generating a first read instruction and sending it to the memory to control the memory to read out the plurality of image correction parameters to the cache;
receiving the image correction parameters and the image data to be processed sent by the cache, and performing correction processing to obtain the corrected image data.

In some embodiments, the clock signal further comprises a second clock signal, and the act of acquiring a plurality of image correction parameters comprises:
determining the image correction parameters, and generating a parameter issuing instruction;
sending the image correction parameter to the cache at a first communication rate in response to the parameter issuing instruction;
under the control of the second clock signal, generating a data writing instruction and sending it to the cache;
receiving the plurality of image correction parameters, and in response to the data writing instruction, writing the plurality of image correction parameters to the memory at a second communication rate;
wherein the first communication rate is greater than the second communication rate.

In some embodiments, the method further includes:
generating a parameter postback instruction;
generating the second read instruction under control of the first clock signal in response to the parameter postback instruction;
reading out the plurality of image correction parameters to the cache at a second communication rate in response to the second read instruction;
wherein the first communication rate is greater than the second communication rate.

In a third aspect, embodiments of the present disclosure provide an image processing device, including:
at least one processor; and
a memory communicatively connected with the at least one processor;
the memory is stored one or more computer programs executable by the at least one processor, the one or more computer programs are executed by the at least one processor to enable the at least one processor to perform the image processing method as described in the second aspect.

In a fourth aspect, embodiments of the present disclosure provide a computer-readable storage medium having stored thereon a computer program, wherein the computer program, when executed by a processor, the image processing method as described in the second aspect is implemented.

In embodiments of the present disclosure, the image correction parameters corresponding to the detection panel are placed in the memory, in view of the non-volatile storage characteristic of the memory, the phenomenon of data loss after power failure is avoided; at the same time, through the cache mechanism of the cache, the problems of limited transmission rate of the memory and unsynchronized communication with other modules during data transmission can be solved; and in the present disclosure, image correction processing is performed through the main control chip. Compared to the way of image correction processing through a host computer software in the prior art, based on the strong serial processing capability of the main control chip, pixel point level operation of high-resolution images can be achieved, with strong real-time processing, which is especially suitable for dynamic acquisition and high-data-volume processing tasks, thus meeting high frame rate and high-resolution image correction requirements for the detection panel, improving the image correction rate and avoiding the phenomena of picture delay and frame drop.

### BRIEF DESCRIPTION OF DRAWINGS

Accompanying drawings are used for providing a further understanding of the present disclosure and constitute a part of the specification, and are used for explaining the present disclosure together with the following specific implementations but does not constitute limitations on the present disclosure. In the drawings:

FIG. 1 is a schematic diagram of a structure of an image processing system according to an embodiment of the present disclosure.

FIG. 2 is a schematic diagram of a flow of an image processing method according to an embodiment of the present disclosure.

FIG. 3 is a schematic diagram of a flow of a parameter issuing according to an embodiment of the present disclosure.

FIG. 4 is a schematic diagram of a flow of a parameter postback according to an embodiment of the present disclosure.

FIG. 5 is a schematic diagram of a flow of an image correction provided by an embodiment of the present disclosure.

FIG. 6 is a schematic diagram of a structure of an image processing device according to an embodiment of the present disclosure.

FIG. 7 is a schematic diagram of a structure of a computer-readable storage medium according to an embodiment of the present disclosure.

### DESCRIPTION OF REFERENCE SIGNS IN THE DRAWING

Main Control Chip 1, Cache DDR, Memory SD, processor 2, Data Transmission Channel 12, Image Acquisition Module 3, Clock Generator 4.

### DETAILED DESCRIPTION

Specific implementations of the present disclosure are described in detail below with reference to the accompanying drawings. It should be understood that the specific implementations described herein are only intended to illustrate and explain the present disclosure and are not intended to limit the present disclosure.

In order to make objectives, technical solutions and advantages of the embodiments of the present disclosure more clear, the technical solutions of the embodiments of the present disclosure will be clearly and completely described below with reference to the drawings of the embodiments of the present disclosure. Apparently, the described embodiments are a part of the embodiments of the present disclosure, not all of the embodiments. Based on the described embodiments of the present disclosure, all other embodiments obtained by those of ordinary skills in the art without paying any inventive effort are within the protection scope of the present disclosure.

Unless otherwise defined, technical terms or scientific terms used in the embodiments shall have common meanings understood by those with ordinary skills in the art to which the present disclosure pertains. The “first”, “second” and similar terms used in the present disclosure do not indicate any order, quantity, or importance, but are used only for distinguishing different components. Likewise, wording such as “include”, “contain” and the like mean that elements or objects appearing before the wording cover elements or objects listed after the wording and their equivalents, but do not exclude other elements or objects. “Connect”, “couple”, or a similar term is not limited to a physical or mechanical connection, but may include an electrical connection, whether direct or indirect. “Upper”, “lower”, “left”, and “right”, etc., are used for representing relative positional relationships, and when an absolute position of a described object is changed, a relative positional relationship may also be correspondingly changed.

A flat X-ray panel detector (FPXD) is a device which converts the energy of X-ray into digital image. FPXD is an important component in digital image technology. Due to its advantages such as fast imaging speed, good spatial and density resolution, high signal-to-noise ratio and direct digital output, it is widely used in the fields of medical imaging (such as X-ray chest radiography), industrial inspection (such as metal detection), security inspection, air transportation.

The production and preparation process of the FPXD is complex, with high requirements for the process and production accuracy, and any minor fluctuations generated during the preparation process may have an impact on the output image. However, in the actual implementation, process fluctuations inevitably exist in the production and preparation process of the FPXD, which in turn leads to the deviations in the pixel parameters of the images captured by the FPXD. Therefore, the correction of the images captured by the FPXD has become an urgent problem to be solved.

In related technologies, the FPXD-based image correction algorithm is processed by a host computer software. For example, after image data is captured on the computer side, a corresponding algorithmic processing is performed to achieve image correction, and the image is finally displayed on a screen. At present, most of image correction algorithms are static image acquisition, while FPXD image acquisition has the characteristics of a larger dynamic range, high acquisition speed and frame rate, and the dynamic acquisition with high frame rate puts higher requirements on the processing capability of the host computer software. In this case, the processing capacity of the algorithm is limited, and it cannot carry such a high amount of data. In view of this, part of the content that is originally processed by the algorithm can be transferred to the board hardware for processing.

Furthermore, when using the board as the main processing main body for the image correction algorithm, the self-processing algorithm of the board involved can be entirely achieved by the board itself. Usually, this algorithm processing is in high demands on the main control chip of the board, and mainly adopts the method of calculating and storing parameters in a RAM. At this time, once the device is powered off, the data in the whole RAM will be lost, and needs to be recalculated after powering up again. In addition, the operation of the whole frame image by the main control chip in the board is complicated and the calculation workload is too large, which seriously affects the efficiency of image correction.

In order to address at least one of the above technologies, embodiments of the present disclosure provide an image processing system, which can meet the correction needs of a detection panel for high frame rate and high resolution images, improve the image correction rate, and avoid the phenomena of picture delay and frame drop.

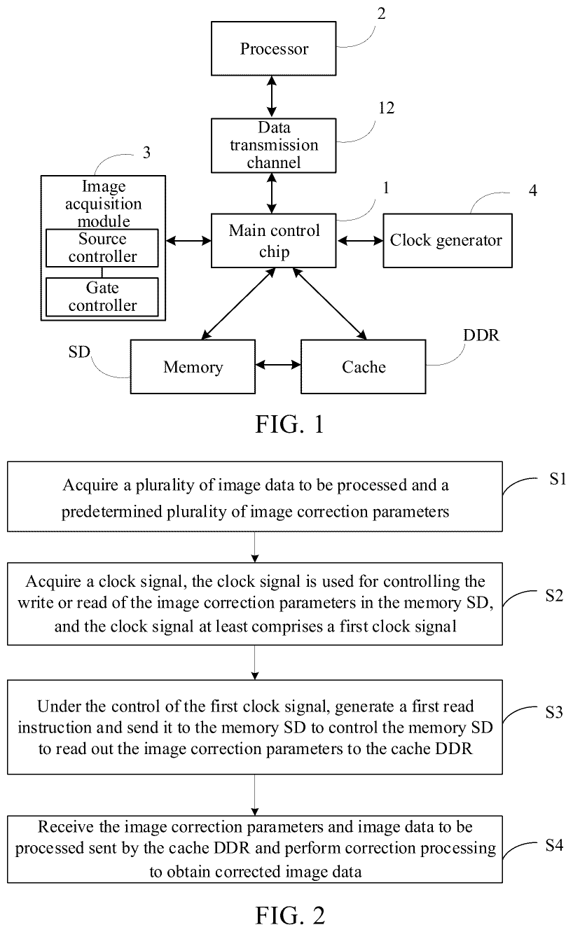

FIG. 1 is a schematic diagram of a structure of an image processing system according to an embodiment of the present disclosure. As shown in FIG. 1, the image processing system comprises a main control chip 1, a memory SD, a cache DDR and a clock generator 4 respectively connected to the main control chip 1, and the memory SD and a cache module DDR are connected to each other.

The memory SD is configured to store a predetermined plurality of image correction parameters; the cache DDR is configured to acquire a plurality of image data to be processed; the clock generator 4 is configured to provide a clock signal for controlling writing or reading of the image correction parameters in the memory SD, the clock signal includes at least a first clock signal; the main control chip 1 is configured to generate a first read instruction under the control of the first clock signal and send the first read instruction to the memory SD to control the memory SD to read out the image correction parameter to the cache DDR; receive the image correction parameters and the image data to be processed sent by the cache, and perform correction processing to obtain the corrected image data.

In embodiments of the present disclosure, the image correction parameters of the detection panel are stored in the memory, in view of the non-volatile storage characteristic of the memory, the phenomenon of data loss after power failure is avoided; at the same time, through the cache mechanism of the cache, the problems of limited transmission rate of the memory and unsynchronized communication with other modules during data transmission can be solved; and in the present disclosure, image correction processing is performed through the main control chip. Compared to the way of image correction processing through a host computer software in the prior art, based on the strong serial processing capability of the main control chip, pixel point level operation of high-resolution images can be achieved, with strong real-time processing, which is especially suitable for dynamic acquisition and high-data-volume processing tasks, thus meeting high frame rate and high-resolution image correction requirements for the detection panel, improving the image correction rate and avoiding the phenomena of picture delay and frame drop.

It should be noted that the above plurality of image data to be processed may be image data corresponding to each pixel point in the image to be processed; the plurality of image correction parameters may be at least one parameter corresponding to each pixel point. Specifically the number of correction parameters corresponding to each pixel point may be determined according to the number of correction types. For example, if the image correction includes three aspects: bad point removal, background noise removal and gain compensation, the plurality of image correction parameters can be three correction parameters corresponding to each pixel point, namely, a bad point removal correction parameter, a background noise removal correction parameters and a gain compensation parameters. Of course, other types of correction may be included in the image correction process and embodiments of the present disclosure are not limited thereto.

In an example, the main control chip described above can be an FPGA chip, which has strong serial processing capability for images, can stably achieve forwarding of parameters and the correction processing of images, and has high reliability.

The memory in embodiments of the present disclosure may be an SD memory card. The SD memory card is a memory device based on a semiconductor flash memory, which has the characteristics of non-volatile storage that does not result in data loss even in the event of a power down, and which is widely used due to its excellent characteristics such as small size, fast data transfer speed, and ability of being hot-swapped. In other embodiments, the memory may be a Flash memory card, a ROM memory, etc., as long as a memory with non-volatile storage characteristics used, and the specific type of the memory is not limited by the embodiments of the present disclosure.

The above-mentioned cache can be a Double Data Rate (DDR) synchronized dynamic random memory, which has an interface with a faster read/write speed and can provide higher bandwidth for data transfer, and is more suitable for the needs of dynamic capture with high frame rates and high resolution.

The clock generator described above may include a clock oscillation circuit, in which the oscillation frequency is accurately determined, and the clock oscillation circuit cooperates with the oscillation circuit in the main control chip to form a “quartz crystal resonator” (referred to as “crystal oscillator”) to generate clock signals needed by each system. In the specific implementation, firstly, a “multivibrator” in the main control chip generates an oscillation with a wide spectrum, and the oscillation signal containing a variety of “harmonic frequencies” is output from the main control chip and is directly added to two ends of the clock oscillation circuit, through accurate frequency selection by the clock oscillation circuit, a required clock frequency is determined, the signal is then fed back to the main control chip to control the oscillation frequency of the “multivibrator”. In this way, the entire clock generator works at the frequency selected by the clock oscillation circuit to produce a clock pulse with stable frequency and constant amplitude to be supplied to the system, so that these storage terminals with different structures and different functions, under the control of the clock signal, work in coordination with each other according to a unified data transmission rate (bit/s) and a specified timing, so as to complete the reception and transmission of image correction parameters and various instructions in an orderly manner.

In some embodiments, as shown in FIG. 1, the image processing system further includes a processor 2 connected to the main control chip 1, and the processor 2 is configured to determine image correction parameters and send the image correction parameters above-described to the memory SD.

It should be understood that the processor 2 may have a specific hardware structure or be a virtual module structure formed by a host computer software, i.e., corresponding functions are achieved through algorithms/programs, which are not limited in embodiments of the present disclosure.

It should be understood that the detection panel needs to be tested for performance after preparation and formation, and during the testing process, a corresponding calibration image, i.e., an original image, is configured to the detection panel to be used for the detection panel to generate correction parameters in its detection. Specifically, the processor 2 sends an original image acquisition instruction to the main control chip 1, and the main control chip 1 controls the image acquisition module 3 to acquire image data in response to the original image acquisition instruction, and returns the acquired original image data to the processor 2. Further, the processor 2 performs data analysis on the original image data based on a preset algorithm to determine image correction parameters corresponding to the detection panel for subsequent image correction.

In addition, in the image correction process, it is mainly divided into two processes: the generation of image correction parameters and the correction processing using the image correction parameters. In the process of generating image correction parameters, in order to ensure the integrity and fluency of the display picture, it is usually needed to obtain the image data of the current frame and the image data of at least one historical frame. When the image is a high frame rate and high resolution image, there will be a very large amount of data generated, and the calculation process is extremely complicated. Based on this, when the processor 2 is the host computer software, the generation of the image correction parameters can be completely executed by the processor 2, and then the image correction parameters, after the generation, are sent to the memory SD.

It should be understood that in the prior art, image correction is performed only by the processor 2, in which case the processor 2 not only needs to receive and display images with high frame rate, but also performs algorithm correction. This process involves repeated reading and writing operations of a large amount of data, and the control process is complex, resulting in a large delay in the algorithmic processing, and even the phenomenon of frame drop may occur, which cannot guarantee a normal display of the image. In embodiments of the present disclosure, on the one hand, the processor 2 executes the act of generating the image correction parameters, on the other hand, the main control chip 1 performs the act of the correction processing by using the image correction parameter, and the cooperative processing mode of the processor 2, i.e., the host computer software, and the main control chip 1, i.e., the board-level main control chip, is used to correct the dynamic high frame rate image, which greatly brings into play the advantages of the processing of software and hardware, reasonably allocates the working mechanism to each module, achieves the image correction processing based on the dynamic high frame rate and high resolution, reasonably utilizes the resources, reduces the cost of the design, and effectively improves the performance of the image correction system.

In some embodiments, the image processing system further includes a data transmission channel 12 connected to the main control chip 1 and the processor 2 respectively, configured to enable communication between the processor 2 and the main control chip 1. In one example, the data transmission channel 12 may be of an Ethernet transmission mechanism, i.e., the main control chip 1 may be connected to the processor 2 through Ethernet to achieve signaling interaction, data uploading and issuing, and the like between the two.

In some embodiments, the clock signal further includes a second clock signal; the processor 2 is configured to determine image correction parameters, generate a parameter issuing instruction and send it to the main control chip 1; the main control chip 1 is further configured to send the image correction parameters to the cache DDR at a first communication rate in response to the parameter issuing instruction; at the same time, under the control of a second clock signal, generate a data writing instruction and send it the cache DDR; the cache DDR is configured to receive a plurality of image correction parameters and, in response to a data writing instruction, write the plurality of image correction parameters to the memory SD at a second communication rate; herein, the first communication rate is greater than the second communication rate.

As can be seen from the above disclosure, the processor 2 generates image correction parameters and sends them to the main control chip 1 via Ethernet and finally stores them in the memory SD. Usually, the transmission rate of a gigabit Ethernet is about 1 Gbit/s, and the transmission rate of a 10 gigabit Ethernet can even reach 10 Gbit/s, while the transmission rate of the memory SD is only about 50 Mbit/s, which means that the rate at which processor 2 issues image correction parameters does not match the rate at which the memory SD writes image correction parameters into its storage space, which leads to the phenomenon of fast transmission and slow writing of parameters, and easily leads to parameter loss.

Based on this, in embodiments of the present disclosure, the image correction parameters issued by the processor 2 are read out to the cache DDR first, so as to solve the problems of Ethernet error packet postback, slow writing of parameters and even loss of parameters due to different rates of parameter issuing and parameter writing; and then the cache DDR slowly stores the image correction parameters into the memory SD to avoid the problem of parameter loss and the need to rewrite the parameters in the event of a power failure of the cache DDR.

Specifically, in embodiments of the present disclosure, a clock signal is generated by the clock generator 4, and the communication rate between the cache DDR and the memory SD is controlled based on the clock signal, so as to minimize the data reading/writing time within the allowable transmission rate of the memory SD and improve the efficiency of image correction. In one example, the clock generator 4 is configured to generate a first clock signal for controlling a read rate at which the cache DDR reads data stored in the memory SD and a second clock signal for controlling a write rate at which the cache DDR writes data to the memory SD.

In some embodiments, the plurality of image correction parameters include a plurality of first parameter groups, each first parameter group includes a sub-parameter corresponding to each pixel point in a frame image, and the sub-parameters in different first parameter groups correspond to different image correction types. The cache DDR is specifically configured to sequentially write the plurality of first parameter groups to the memory SD in a preset order at the second communication rate in response to the data writing instruction.

It should be noted that the correction processing performed by the main control chip 1 based on the image correction parameters includes a plurality of correction types such as bad point removal correction, background noise removal correction, gain compensation and the like. Based on this, the above plurality of first parameter groups may be a bad point removal correction parameter group, a background noise removal correction parameter group and a gain compensation parameter group, herein the bad point removal correction parameter group includes a bad point removal correction parameter corresponding to each pixel point in the frame image; the background noise removal correction parameter group includes a background noise removal correction parameter corresponding to each pixel point in the frame image; the gain compensation parameter group includes a gain compensation parameter corresponding to each pixel point in the frame image. That is, different first parameter groups are written into the memory SD one by one according to the correction type. In addition, the writing order for a plurality of types of first parameter groups is not limited in embodiments of the present disclosure.

In some embodiments, the main control chip 1 is further configured to generate a first feedback instruction after all the first parameter groups are stored in the memory SD, and send the first feedback instruction to the processor 2, and the first feedback instruction is used to indicate that the issuance of the plurality of the first parameter groups is complete.

Because the processor 2 transmits the image correction parameters to the main control chip 1 through the data transmission channel 12, i.e., Ethernet, at a high speed, and the memory SD is written at a low speed under the caching of the cache DDR, the communication rates of the two do not match and communication synchronization cannot be achieved. Therefore, after the cache DDR has written all of the image correction parameters into the memory SD, the main control chip 1 needs to send a first feedback instruction to the processor 2 to form a complete issuance process of the image correction parameters.

Combined with the above analysis, it can be seen that in embodiments of the present disclosure, on the one hand, the processor 2 executes the act of generating the image correction parameters, and on the other hand, the main control chip 1 executes the act of performing correction processing using the image correction parameters. Herein, the image correction parameters are related to the model of its corresponding detection panel.

Based on this, when replacing the mobile terminal corresponding to the processor 2, it is needed to post back parameters. Specifically, the foregoing has shown that the processor 2 is a host computer software, that is, it is achieved by a mobile terminal. A mobile terminal A determines image correction parameters and stores them in the memory SD. Further, when the mobile terminal A is damaged, it can be replaced by a mobile terminal B. At this time, it is only needed to switch the communication interface between the mobile terminal and the main control chip 1, and the image correction parameters stored in the memory SD are posted back to the mobile terminal B after the connection is established, thereby eliminating the need to recalculate and determine parameters and saving the calculation resources.

In addition, in an example, because the mobile terminal and the main control chip 1 are connected via the communication interface, for the same mobile terminal, it can be connected with the main control chip 1A or the main control chip 1B, the main control chip 1A is the control terminal corresponding to the detection panel A, and the main control chip 1B is the control terminal corresponding to the detection panel B. Further, the processor 2 stores the image correction parameter A corresponding to the detection panel A. When the processor 2 switches its communication interface to be connected with the main control chip 1B, the processor 2 can directly perform data analysis on the image correction parameter A based on the product universality between the detection panels A and B, and determine the image correction parameter B by a preset algorithm to be used for subsequent image correction processing, thus greatly saving computational resources.

It should also be noted that the communication connection between the detection panel and the main control chip can be carried out through an independently arranged interface board, that is, in the case that the main control chip is fixed and unchanged, only the interface board needs to be replaced to achieve the image acquisition of the detector panels of different models.

In some embodiments, the processor 2 is configured to generate a parameter postback instruction and send it to the main control chip 1; the main control chip 1 is further configured to generate a second read instruction under the control of the first clock signal in response to the parameter postback instruction and send the second read instruction to the memory SD; the memory SD is configured to read a plurality of image correction parameters at a second communication rate in response to the second read instruction to be cached in the cache DDR; the cache DDR is configured to upload the plurality of image correction parameters to the processor 2 via the main control chip 1 at a first communication rate; herein, the first communication rate is greater than the second communication rate.

During the parameter postback process, the memory SD reads data at a slow rate while the processor 2 receives data at a fast rate. Therefore, the main control chip 1 controls the cache DDR to read out the image correction parameters at a slow rate, that is, the image correction parameters are cached in the cache DDR and transmitted to the processing unit at a high speed by the cache DDR, so as to solve the problem of mismatch in the communication rate between the memory SD and the processor 2.

In some embodiments, the plurality of image correction parameters include a plurality of second parameter groups, each second parameter group includes a plurality of sub-parameters corresponding to one of the pixel points in the frame image, pixel points corresponding to the sub-parameters in different second parameter groups are different; the cache DDR is specifically configured to sequentially read the plurality of second parameter groups in the memory SD in a preset order at a second communication rate.

It is known from the foregoing description that the cache DDR receives data at a slow rate and sends data to the processor 2 at a fast rate during the parameter postback process. In order to avoid the phenomena of clock crosstalk and data packet loss, the cache DDR in embodiments of the present disclosure adopts a time division processing mode to carry out the parameter receiving and transmitting operations respectively.

In some embodiments, the cache is specifically configured to sequentially receive the plurality of second parameter groups in the memory in a preset order at the second communication rate; after all the second parameter groups are received, post back the plurality of second parameter groups to the processor via the main control chip at the first communication rate. The cache is based on time division processing, which avoids the phenomena of clock crosstalk and data packet loss, and solves the problems of mismatched clocks between the memory and processor and inconsistent communication rate.

In some embodiments, the processor 2 is further configured to generate an image correction instruction and send it to the main control chip 1; the main control chip 1 is further configured to generate a first read instruction under the control of the second clock signal in response to the image correction instruction and send the first read instruction to the cache DDR; the cache DDR is further configured to read the plurality of image correction parameters in the memory SD at the second communication rate in response to the first read instruction.

In the implementation of the present disclosure, the processor 2 issues an image correction instruction, and the main control chip 1 generates a first read instruction in response to the image correction instruction, so as to control the cache DDR to read the image correction parameters stored in the memory SD through the first read instruction.

In the process of image correction, the image correction parameters need to be first cached to the cache DDR for the main control chip 1 to perform correction processing on the image data to be processed based on the parameters. It should be understood that at the time of correction processing, the main control chip 1 processes a plurality of pixel points in the image one by one, and for each pixel point, it corresponds to a plurality of correction types. For example, in a same example as the above-described example, each pixel point corresponds to three image correction parameters which are respectively a bad point removal correction parameter, a background noise removal correction parameter and a gain compensation parameter. At this time, when the main control chip 1 performs correction processing for each pixel point, it should acquire image data to be processed corresponding to the pixel point and the above three sub-parameters, before correction.

In some embodiments, the plurality of image correction parameters include a plurality of second parameter groups, each second parameter group includes a plurality of sub-parameters corresponding to one of the pixel points in the frame image, and pixel points corresponding to the sub-parameters in different second parameter groups are different. The memory SD is specifically configured to, in response to the first read instruction, sequentially read the plurality of second parameter groups at the second communication rate and in a preset order to be cached to the cache DDR.

That is, the main control chip 1 first places image data and correction parameters corresponding to each pixel point in the cache DDR. Specifically, the cache DDR, in response to the first read instruction, acquires image data to be processed of the target pixel point, and simultaneously acquires the second parameter group of the target pixel point, which includes a bad point removal correction parameter, a background noise removal correction parameter and a gain compensation parameter corresponding to the target pixel point.

In the process of parameter issuing, the image correction parameters are transmitted from the processor 2 to the main control chip 1, then to the cache DDR, and written from the cache DDR to the memory SD, and the parameters are all written sequentially. For example, when there are n pixels, the writing order is from a bad point removal correction parameter module (1˜n), to a background noise removal n parameter module (1˜n), and a gain compensation parameter module (1˜n). However, during image correction, the reading of parameters needs to be done through skipping reading. Specifically, in the parameter read-write control of the cache DDR, because the main control chip 1 has the characteristic of serial processing, it is needed to synchronously obtain the image data to be processed and the correction parameters of three algorithms corresponding to the target pixel point at the same time point. The order is from 1 (bad point removal 1, background noise removal 1, gain compensation 1), to 2 (bad point removal 2, background noise removal 2, gain compensation 2) . . . n (bad point removal n, background noise removal n, gain compensation n), thus achieving the image correction processing of the main control chip 1 at pixel level.

In some embodiments, the cache DDR is further configured to perform data consolidation on the plurality of image data to be processed and the plurality of second parameter groups to determine the image data to be processed and the second parameter group corresponding to each pixel point. The main control chip 1 is specifically configured to, according to the image data to be processed and the second parameter group corresponding to each pixel point, perform image correction processing on each pixel point in a plurality of pixel points in the frame image to obtain corrected image data corresponding to each pixel point.

In embodiments of the present disclosure, the process of obtaining corrected image data by performing image correction processing by means of a preset algorithm will not be repeated.

In some embodiments, the processor 2 is further configured to receive a plurality of corrected image data at a first communication rate; form a corrected frame image based on the plurality of corrected image data; herein, the first communication rate is greater than the second communication rate.

It should be understood that the image correction processing performed by the main control chip 1 is a pixel level processing thread, and based on this, a drive signal can be generated from the corrected image data by the processor 2 to form a corrected frame image on the detection panel.

In some embodiments, the first communication rate is the communication rate between the data transmission channel 12 and the processor 2, and the second communication rate is the communication rate when the memory SD writes or reads data, herein, the first communication rate is 0.7 Gbit/s to 10 Gbit/s, and the second communication rate is 40 Mbit/s-60 Mbit/s.

In some embodiments, as shown in FIG. 1, the image processing system further includes a processor 2 and an image acquisition module 3 respectively connected to the main control chip 1. The processor 2 is configured to generate an image acquisition instruction and send it to the main control chip 1; the main control chip 1 is configured to control the image acquisition module 3 to acquire data in response to the image acquisition instruction; the image acquisition module 3 is configured to acquire a plurality of image data to be processed according to a frame image and send them to the cache DDR.

Specifically, the above-described image acquisition instruction can be an acquisition instruction for an image to be processed or an acquisition instruction for an original image, which is not limited in embodiments of the present disclosure.

In one example, the image acquisition module 3 includes a source controller and a gate controller, and the main control chip 1 acquires image data to be processed by controlling the drive timing of the two.

In some embodiments, the image acquisition module 3 is further configured to display based on the corrected image data to display the corrected frame image.

It is understood that, in embodiments of the present disclosure, the image data acquired by the image acquisition module 3 is data on the detection panel.

In summary, in the image correction system according to an embodiment of the present disclosure, there are many read and write control operations for the cache DDR. In particular, the cache DDR can play the following roles: first, in the process of parameter issuing, the image correction parameters are received at a fast rate, and the image correction parameters are written into the memory SD at a slow rate, which solves the problem of the clock unsynchronization of the Ethernet write and the memory SD write, and avoids the problem of parameter loss which in turn leads to the problem that the image can't be displayed normally due to frame drop. Second, it avoids the mechanism of retransmission of wrong packets in Ethernet transmission when reading the parameters and writing the parameters to its own storage space. Third, the read operation in image correction or in parameter postback for the cache DDR is not processed in parallel, but in time division. That is, the cache DDR first reads out the image correction parameters from the memory SD at the second communication rate, and sends them to the processor 2 at the first communication rate after all the reading is completed. Fourth, in the process of parameter postback or image correction, the parameters in the memory SD are read and then written into the cache DDR, which solves the problem of the unsynchronization of the clock for the read of the memory SD and the clock for the image processing or Ethernet postback module.

In embodiments of the present disclosure, the function of image correction is moved to the main control chip by adding a cache DDR and a memory SD in the image processing system; at the same time, considering the problem that the main control chip is not good at data block operation, in an early stage, the image correction parameters are generated in advance by the host computer software, i.e., the processor, and are issued to the main control chip, the main control chip stores them in the memory. Thus, in the process of normal image acquisition, the main control chip can read the parameters in the memory, perform correction processing on the acquired image data to be processed, make full use of the serial processing ability of the main control chip, and finally transmit the corrected image data to the processor, which effectively ensures the demand of the processing speed and high frame rate of the image.

Based on the same inventive concept mentioned above, embodiments of the present disclosure further provides an image processing method, which is applied to the image processing system provided in any of the above embodiments.

FIG. 2 is a schematic diagram of a flow of an image processing method according to an embodiment of the present disclosure. As shown in FIG. 2, the image processing method comprises acts S1 to S4, as follows:

In act S1, acquiring a plurality of image data to be processed and a predetermined plurality of image correction parameters.

In act S2, acquiring a clock signal, the clock signal is used for controlling the write or read of the image correction parameters in the memory SD, and the clock signal at least comprises a first clock signal.

Herein, the first clock signal is used for controlling a read rate at which the cache DDR reads data stored in the memory SD; the clock signal may further include a second clock signal for controlling a write rate at which the cache DDR writes data to the memory SD.

In act S3, under the control of the first clock signal, generating a first read instruction and sending it to the memory SD to control the memory SD to read out the image correction parameters to the cache DDR.

In act S4, receiving the image correction parameters and image data to be processed sent by the cache DDR and performing correction processing to obtain corrected image data.

In embodiments of the present disclosure, the image correction parameters are placed in the memory SD, because of the non-volatile storage characteristic of the memory SD, the phenomenon of data loss after power failure is avoided; at the same time, through the cache mechanism of the cache DDR, the problems of unsynchronized communication between the memory SD and other modules during data transmission, due to the limited transmission rate of the memory SD, can be solved.

It should be noted that the image processing method according to an embodiment of the present disclosure is applied to the above-mentioned image processing system, and the specific structure of the image processing system and function of each module are shown in FIG. 1 and the above-mentioned embodiment, which will not be repeated in detail.

In conjunction with each module in FIG. 1, the image processing method according to an embodiment of the present disclosure will be described below in detail with specific embodiments corresponding to three processing procedures: parameter issuing, parameter postback and image correction.

### Embodiment 1, Parameter Issuing

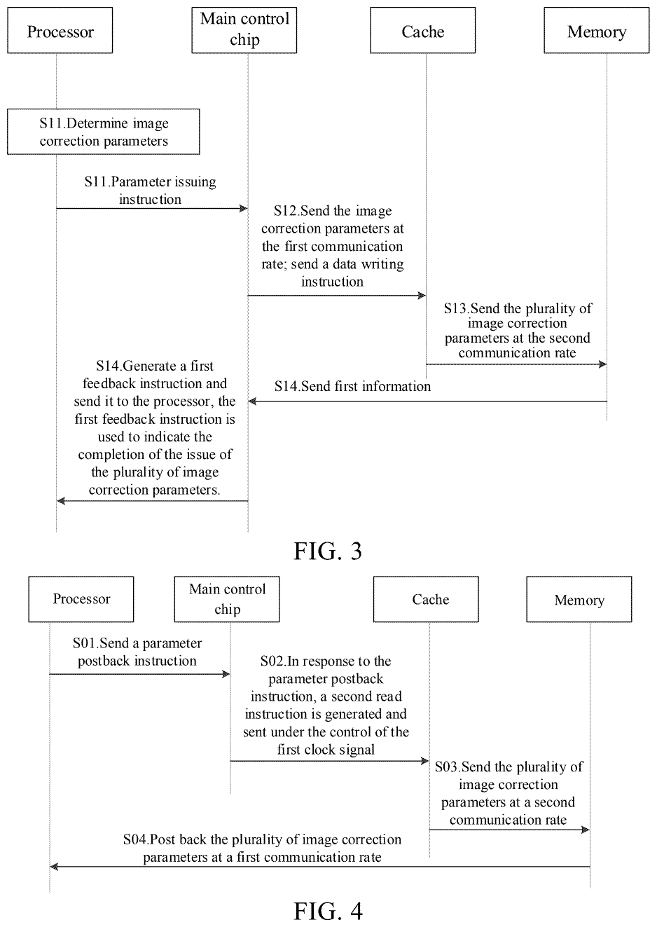

FIG. 3 is a schematic diagram of a flow of a parameter issuing according to an embodiment of the present disclosure. As shown in FIG. 3, the image correction parameters determined by the processor 2 are issued to the memory SD, that is, the act of acquiring a plurality of image correction parameters in act S1 includes following acts.

In act S11, the processor 2 determines the image correction parameters and generates a parameter issuing instruction.

The processor 2 determining the image correction parameters may include: the processor 2 sends an original image acquisition instruction to the main control chip 1, and the main control chip 1, in response to the original image acquisition instruction, controls the image acquisition module 3 to acquire image data, and returns the acquired original image data to the processor 2. Further, the processor 2 performs data analysis on the original image data based on a preset algorithm to determine the image correction parameters for subsequent image correction.

In some embodiments, the image acquisition module 3 may be a detection panel and the processor determines the image correction parameters corresponding to the detection panel. It should be understood that the production and preparation process of the detection panel is complex, with high requirements for technological process and production accuracy, and any minor fluctuations generated during the production process may have an impact on the output image. However, in the actual implementation, process fluctuations inevitably exist in the production and preparation process of detection panels, and detection panels of different sizes and different models have different differences formed at the final product end. Based on this, for detection panels of different models, the processor analyzes the original image data and determines the corresponding image correction parameters with a preset algorithm.

The above-described parameter issuing instruction is sent to the main control chip 1 through the data transmission channel 12, that is, through the Ethernet transmission.

In act S12, the main control chip 1 sends the image correction parameters to the cache DDR at the first communication rate in response to the parameter issuing instruction; under the control of the second clock signal, generates and sends a data writing instruction to the cache DDR.

In act S13, the cache DDR receives the plurality of image correction parameters and, in response to the data writing instruction, writes the plurality of image correction parameters to the memory SD at a second communication rate, herein, the first communication rate is greater than the second communication rate.

Specifically, the plurality of image correction parameters include a plurality of first parameter groups, each first parameter group includes a sub-parameter corresponding to each pixel point in a frame image, and the sub-parameters in different first parameter groups correspond to different image correction types. The cache DDR is specifically configured to sequentially write the plurality of first parameter groups to the memory SD in a preset order at the second communication rate in response to the data writing instruction.

The above plurality of first parameter groups may be a bad point removal correction parameter group, a background noise removal correction parameter group and a gain compensation parameter group, the bad point removal correction parameter group includes a bad point removal correction parameter corresponding to each pixel point in the frame image; the background noise removal correction parameter group includes a background noise removal correction parameter corresponding to each pixel point in the frame image; the gain compensation parameter group includes a gain compensation parameter corresponding to each pixel point in the frame image. That is, different first parameter groups are written into the memory SD one by one according to the correction type.

In act S14, after writing the plurality of image correction parameters to the memory SD is completed, a first information is fed back to the main control chip 1; after the main control chip 1 receives the first information, it generates a first feedback instruction and sends the first feedback instruction to the processor 2. The first feedback instruction is used to indicate the completion of the issue of the plurality of image correction parameters.

### Embodiment 2, Parameter Postback

FIG. 4 is a schematic diagram of a flow of a parameter postback according to an embodiment of the present disclosure. As shown in FIG. 4, after the parameter is issued, the image processing method may further include: posting back the image correction parameters determined by the processor to the processor 2, which may include acts S01 to S03, as follows:

In act S01, the processor 2 generates a parameter postback instruction.

The above-described parameter postback instruction is transmitted to the main control chip 1 through the data transmission channel 12, that is, through the Ethernet transmission.

In act S02, in response to the parameter postback instruction, a second read instruction is generated under the control of the first clock signal and sent to the memory SD.

In act S03, the memory SD, in response to the second read instruction, reads out a plurality of image correction parameters to the cache at a second communication rate.

In act S04, the cache DDR uploads the plurality of image correction parameters at a first communication rate; wherein the first communication rate is greater than the second communication rate.

It should be noted that the write operation in image correction or the read/write operation in parameter postback for the cache DDR is not processed in parallel, but is processed in a time division manner. That is, the cache DDR first reads out the image correction parameters from the memory SD at the second communication rate, and after all the transmission is completed, sends the image correction parameters to the processor 2 at the first communication rate. Herein, the first communication rate and the second communication rate are transmission rates of different levels, i.e., the rate at which the cache DDR sends parameters is much greater than the rate at which the cache DDR receives parameters. At this time, the cache DDR does not adopt parallel processing, that is, it does not handle parameters through simultaneous reception and transmission. Instead, the operations of receiving and transmitting parameters are kept separate and independent from each other, without any interference between the two. Thus, the clock crosstalk and data packet loss are avoided. Moreover, the image correction parameters correspond to each pixel point on the detection panel, and the orderly transmission of the image correction parameters can ensure the effectiveness of image correction.

### Embodiment 3, Image Correction

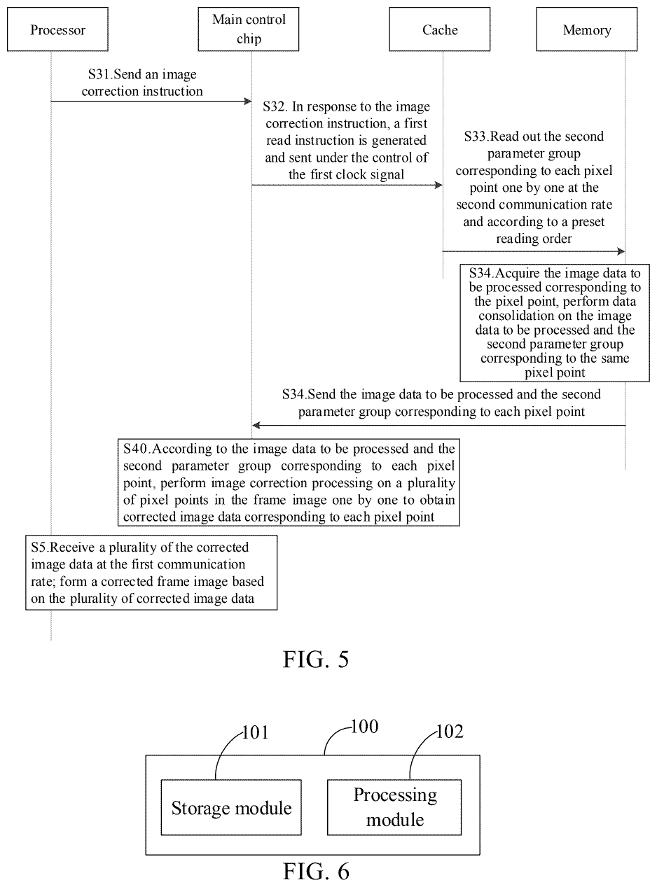

FIG. 5 is a schematic diagram of a flow of an image correction provided by an embodiment of the present disclosure. As shown in FIG. 5, the process in which the main control chip 1 acquires image correction parameters and corrects the image data to be processed according to the image correction parameters may include the above acts S3, S4 and S5, wherein the act S3 includes acts S31-S34, and the act S4 includes act S40, as follows:

In act S31, the processor 2 generates an image correction instruction.

In act S32, the main control chip 1, in response to the image correction instruction, generates a first read instruction under the control of the first clock signal, and sends the first read instruction to the memory SD.

In act S33, the memory SD, in response to the first read instruction, reads out the second parameter group corresponding to each pixel point one by one at the second communication rate and according to a preset reading order. Herein, the above-described second parameter group comprises a plurality of sub-parameters corresponding to one of the pixels in the frame image, and pixel points corresponding to the sub-parameters in different second parameter groups are different. Specifically, the second parameter group comprises a bad point removal correction parameter, a background noise removal correction parameter and a gain compensation parameter corresponding to the target pixel point.

In act S34, the cache DDR, while receiving a second parameter group corresponding to a pixel point, acquires the image data to be processed corresponding to the pixel point, performs data consolidation on the image data to be processed and the second parameter group corresponding to the same pixel point, determines the image data to be processed and the second parameter group corresponding to each pixel point, and sends them to the main control chip.

The image data to be processed corresponding to the pixel points is acquired by the image acquisition module 3.

That is to say, in the process of image correction, the reading of parameters needs to be done through skipping reading. Specifically, in the parameter read-write control of the cache DDR, because the main control chip 1 has the characteristic of serial processing, it is needed to synchronously obtain the image data to be processed and the correction parameters of three algorithms corresponding to the target pixel point at the same time point. The order is from 1 (bad point removal 1, background noise removal 1, gain compensation 1), 2 (bad point removal 2, background noise removal 2, gain compensation 2) . . . to n (bad point removal n, background noise removal n, gain compensation n), thus achieving the image correction processing of the main control chip at 1-pixel level.

In act S40, according to the image data to be processed and the second parameter group corresponding to each pixel point, the main control chip 1 performs image correction processing on a plurality of pixel points in the frame image one by one to obtain corrected image data corresponding to each pixel point.

In act S5, the processor 2 receives a plurality of the corrected image data at the first communication rate; forms a corrected frame image based on the plurality of corrected image data.

FIG. 6 is a schematic diagram of a structure of an image processing device according to an embodiment of the present disclosure. As shown in FIG. 6, the electronic device 100 includes a storage module 101 and a processing module 102. The storage module 101 is stored a computer program, wherein when the computer program is executed by the processing module 102, the image processing method described above is implemented, for example, acts S1 to S4 in FIG. 2 are implemented.

The electronic device 100 may be a computing device such as a desktop computer, a notebook, a palmtop computer and a cloud server. The electronic device 100 may include, but is not limited to the processing module 102 and the storage module 101. Those skilled in that art understand that FIG. 6 is merely an example of the electronic device 100 and does not constitute a limitation to the electronic device 100, which may include more or fewer components than illustrated, or may be combined with certain components, or different components, for example, the electronic device 100 may include input/output devices, network access devices, buses, and the like.

The processing module 102 may be a Central Processing Unit (CPU), other general purpose processors, Digital Signal Processors (DSP), Application Specific Integrated Circuit (ASIC), Field-Programmable Gate Array (FPGA) or other programmable logic device, discrete gate or transistor logic device, discrete hardware component, and the like. The general purpose processing module 102 may be a microprocessor or the processor may be any conventional processor or the like.

The storage module 101 may be an internal storage unit of the electronic device 100, such as a hard disk or memory of the electronic device 100. The storage module 101 may be an external storage device of the electronic device 100, such as a plug-in hard disk, a Smart Media Card (SMC), a Secure Digital (SD) card, a Flash Card, and the like, provided on the electronic device 100. Further, the storage module 101 may include both an internal storage unit and an external storage device of the electronic device 100. The storage module 101 is used for storing the computer program and other programs and data required by the terminal device. The storage module 101 may be used to temporarily store data that has been or will be output.

Those skilled in the art can clearly understand that, for convenience and conciseness of description, the division of the above functional units and modules is only illustrated as an example. In practical application, the above-described functions can be assigned to be accomplished by different functional units and modules according to the needs, that is, the internal structure of the apparatus can be divided into different functional units or modules to accomplish all or part of the above described functions. Each functional unit and module in the embodiment can be integrated in one processing unit, or each unit can exist physically separately, or two or more units can be integrated in one unit. The integrated units can be achieved either in the form of hardware or in the form of a software functional unit. In addition, the specific names of each functional unit and module are only for the purpose of facilitating mutual differentiation, and are not used to limit the scope of protection of the present application. The specific working process of the units and modules in the above system can be referred to the corresponding process in the aforementioned method embodiment, and will not be repeated here.

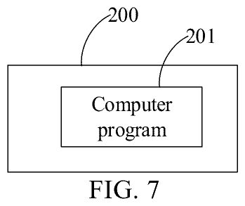

FIG. 7 is a schematic diagram of a structure of a computer-readable storage medium according to an embodiment of the present disclosure. As shown in FIG. 7, a computer program 201 is stored on the computer-readable storage medium 200. When the computer program 201 is executed by a processor, the above image processing method is implemented, for example, acts S1 to S4 in FIG. 2 are implemented. The computer readable storage medium 200 includes, but is not limited to, an RAM, an ROM, an EEPROM, a flash memory or another memory technology, a CD-ROM, a Digital Versatile Disk (DVD) or another optical disk storage, a magnetic cartridge, a magnetic tape, magnetic disk storage or another magnetic storage apparatus, or any other medium that may be configured to store desired information and may be accessed by a computer. In addition, it is known to those of ordinary skill in the art that the communication medium usually includes a computer-readable instruction, a data structure, a program module, or other data in a modulated data signal of, such as, a carrier or another transmission mechanism, and may include any information delivery medium.

It is to be understood that the above embodiments are only exemplary embodiments employed for the purpose of illustrating the principles of the present disclosure, however the present disclosure is not limited thereto. To those of ordinary skills in the art, various modifications and improvements may be made without departing from the essence and substance of the present disclosure, and these modifications and improvements are also considered to be within the scope of the present disclosure.

1. An image processing system, comprising a main control chip, a memory, a cache, and a clock generator respectively connected to the main control chip, wherein:
the memory and the cache are connected to each other;
the memory is configured to store a predetermined plurality of image correction parameters;
the cache is configured to acquire a plurality of image data to be processed;
the clock generator is configured to provide a clock signal for controlling writing or reading of the image correction parameters in the memory, wherein the clock signal comprises at least a first clock signal; and
the main control chip is configured to: under control of the first clock signal, generate a first read instruction and send the first read instruction to the memory to control the memory to read out the plurality of image correction parameters to the cache; receive the image correction parameters and the image data to be processed sent by the cache; and perform correction processing to obtain the corrected image data.

2. The image processing system according to claim 1, wherein:
the clock signal further comprises a second clock signal;
the image processing system further comprises a processor connected with the main control chip;
the processor is configured to determine the image correction parameters; and generate a parameter issuing instruction and send the parameter issuing instruction to the main control chip;
the main control chip is further configured to: send the image correction parameters to the cache at a first communication rate in response to the parameter issuing instruction; at the same time, under control of the second clock signal, generate a data writing instruction and send the data writing instruction to the cache;
the cache is configured to: receive the plurality of image correction parameters, and in response to the data writing instruction, write the plurality of image correction parameters to the memory at a second communication rate; and
the first communication rate is greater than the second communication rate.

3. The image processing system according to claim 2, wherein:
the plurality of image correction parameters comprise a plurality of first parameter groups, each of the first parameter groups comprises a sub-parameter corresponding to each pixel point in a frame image, and image correction types corresponding to the sub-parameters in different first parameter groups are different; and
the cache is configured to sequentially write the plurality of the first parameter groups into the memory in a preset order at the second communication rate in response to the data writing instruction.

4. The image processing system according to claim 3, wherein the main control chip is further configured to:
after the plurality of the first parameter groups are all stored in the memory, generate a first feedback instruction and send the first feedback instruction to the processor, wherein the first feedback instruction is used to indicate completion of issuing the plurality of the first parameter groups.

5. The image processing system according to claim 31, wherein:
the image processing system further comprises a processor connected to the main control chip;
the processor is configured to generate a parameter postback instruction and send the parameter postback instruction to the main control chip;
the main control chip is further configured to in response to the parameter postback instruction, generate a second read instruction under control of the first clock signal and send the second read instruction to the memory;
the memory is configured to read out the plurality of image correction parameters to the cache at a second communication rate in response to the second read instruction;
the cache is configured to post back the plurality of image correction parameters to the processor via the main control chip at a first communication rate; and
the first communication rate is greater than the second communication rate.

6. The image processing system according to claim 5, wherein the plurality of image correction parameters comprise a plurality of second parameter groups, each of the second parameter groups comprises a plurality of sub-parameters corresponding to one of pixel points in a frame image, pixel points corresponding to the sub-parameters in different second parameter groups are different; and
the cache is configured to sequentially receive the plurality of second parameter groups in the memory according to a preset order at the second communication rate.

7. The image processing system according to claim 6, wherein the cache is further configured to:
postback the plurality of second parameter groups to the processor via the main control chip at a first communication rate after all second parameter groups have been received.

8. The image processing system according to claim 6, wherein:
the frame image comprises n pixel points, and the plurality of image correction parameters comprise a first sub-parameter, a second sub-parameter, and a third sub-parameter corresponding to each pixel point;
the cache is configured to write n first sub-parameters, n second sub-parameters and n third sub-parameters to the memory sequentially at the second communication rate in response to a data writing instruction; and
the memory is configured to read out the three sub-parameters corresponding to pixel point 1 to pixel point n to the cache sequentially at the second communication rate in response to the second read instruction.

9. The image processing system according to claim 31, wherein:
the clock signal further comprises a second clock signal;
the image processing system further comprises a processor connected with the main control chip, wherein the processor is configured to generate an image correction instruction and send the image correction instruction to the main control chip;
the main control chip is further configured to generate the first read instruction under control of the second clock signal in response to the image correction instruction and send the first read instruction to the memory; and
the memory is further configured to read out the plurality of image correction parameters to the cache at a second communication rate in response to the first read instruction.

10. The image processing system according to claim 9, wherein the plurality of image correction parameters comprise a plurality of second parameter groups, each of the second parameter groups comprises a plurality of sub-parameters corresponding to one of pixel points in a frame image, pixel points corresponding to the sub-parameters in different second parameter groups are different; and
the memory is configured to sequentially read the plurality of second parameter groups in a preset order at the second communication rate in response to the first read instruction, and cache the plurality of second parameter groups in the cache.

11. The image processing system according to claim 10, wherein:
the cache is further configured to: perform data consolidation on the plurality of image data to be processed and the plurality of second parameter groups to determine the image data to be processed and the second parameter group corresponding to each pixel point, and send the image data to be processed and the second parameter group corresponding to each pixel point to the main control chip; and
the main control chip is configured to: according to the image data to be processed and the second parameter group corresponding to each pixel point, perform image correction processing on a plurality of pixel points in the frame image one by one to obtain corrected image data corresponding to each pixel point.

12. The image processing system according to claim 11, wherein:
the frame image comprises n pixel points, and the plurality of image correction parameters comprise a first sub-parameter, a second sub-parameter, and a third sub-parameter corresponding to each pixel point;
the cache is configured to write n first sub-parameters, n second sub-parameters and n third sub-parameters to the memory sequentially at the second communication rate in response to a data writing instruction;
the memory is configured to read out the three sub-parameters corresponding to pixel point 1 to pixel point n to the cache sequentially at the second communication rate in response to the first read instruction; and
the cache is further configured to perform following acts in a preset order for pixel point 1 to pixel point n:
receiving three sub-parameters corresponding to pixel point i, at the same time, configuring image data to be processed corresponding to the pixel point i, and sending the image data to be processed corresponding to the pixel point i and the three sub-parameters to the main control chip, wherein, 1≤i≤n.

13. The image processing system according to claim 11, wherein the processor is further configured to:
receive a plurality of corrected image data at a first communication rate; and
form a corrected frame image based on the plurality of corrected image data, wherein the first communication rate is greater than the second communication rate.

14. The image processing system according to claim 2, wherein the first communication rate is 0.7 Gbit/s to 10 Gbit/s and the second communication rate is 40 Mbit/s to 60 Mbit/s.

15. The image processing system according to claim 1, wherein:
the image processing system further comprises a processor and an image acquisition module respectively connected with the main control chip;
the processor is configured to generate an image acquisition instruction and send the image acquisition instruction to the main control chip;
the main control chip is configured to control the image acquisition module to perform data acquisition in response to the image acquisition instruction; and
the image acquisition module is configured to acquire the plurality of image data to be processed according to a frame image and send the plurality of image data to be processed to the cache.

16. An image processing method for the image processing system according to claim 1, wherein the method comprises:
acquiring the plurality of image data to be processed and the predetermined plurality of image correction parameters;
acquiring the clock signal for controlling writing or reading of the image correction parameters in the memory, the clock signal comprises at least the first clock signal;
under the control of the first clock signal, generating the first read instruction and sending the first read instruction to the memory to control the memory to read out the plurality of image correction parameters to the cache; and
receiving the image correction parameters and the image data to be processed sent by the cache, and performing correction processing to obtain the corrected image data.

17. The image processing method according to claim 16, wherein the clock signal further comprises a second clock signal, and acquiring the plurality of image correction parameters comprises:
determining the image correction parameters, and generating a parameter issuing instruction;
sending the image correction parameter to the cache at a first communication rate in response to the parameter issuing instruction;
under control of the second clock signal, generating a data writing instruction and sending the data writing instruction to the cache; and
receiving the plurality of image correction parameters, and in response to the data writing instruction, writing the plurality of image correction parameters to the memory at a second communication rate, wherein the first communication rate is greater than the second communication rate.

18. The image processing method according to claim 16, wherein the method further comprises:
generating a parameter postback instruction;
generating a second read instruction under control of the first clock signal in response to the parameter postback instruction;
reading out the plurality of image correction parameters to the cache at a second communication rate in response to the second read instruction; and
uploading the plurality of image correction parameters at a first communication rate, wherein the first communication rate is greater than the second communication rate.

19. An image processing device, comprising:
at least one processor; and
a memory communicated and connected with the at least one processor, wherein the memory is stored one or more computer programs executable by the at least one processor, the one or more computer programs are executed by the at least one processor to enable the at least one processor to perform the image processing method of claim 16.

20. A non-transitory computer-readable storage medium, stored thereon a computer program, wherein when the computer program is executed by a processor, the image processing method according to claim 16 is implemented.
